(19) United States
(12) Patent Application Publication
(10) Pub. No.: US 2010/0186333 A1
(43) Pub. Date: Jul. 29, 2010

(54) Modular Tile Panel and Associated Methods

(76) Inventor: Gary Miller, San Diego, CA (US)

Correspondence Address: John Karl Buche;BUCHE & ASSOCIATES, P.C., 875 PROSPECT, SUITE 305, LA JOLLA, CA, 92037, US

(21) Appl. No.: 12/692,555

(22) Filed: Jan. 22, 2010

Related U.S. Application Data
(60) Provisional application No. 61/147,075, filed on Jan. 24, 2009.

(51) Int. Cl. E04C 2/34; E04C 2/38; E04B 2/32; B23P 17/04; B29C 65/00

(52) U.S. Cl. 52/483.1; 52/793.1; 52/578; 29/428; 156/60

(57) ABSTRACT

Disclosed is a panel assembly including methods of assembly and installation.

### CROSS-REFERENCE TO RELATED APPLICATIONS

This application claims the benefit of U.S. Prov. Pat. App. Ser. No. 61/147,075 (filed Jan. 24, 2009) entitled “Modular Tile Panel and Associated Methods.”

### STATEMENT REGARDING FEDERALLY SPONSORED RESEARCH OR DEVELOPMENT

Not applicable.

### BACKGROUND OF THE INVENTION

1. Field of Invention

The following relates to panel assemblies comprising at least one tile, decorative ornament, covering material, or protective member and which assemblies are configured for installation on a support. The following also relates to panel assemblies comprising at least one tile, decorative ornament, covering material, or protective member wherein any two of said panel assemblies may be installed adjacent to one another to form a waterproof seal. The following also relates to panel assemblies comprising at least one tile, decorative ornament, covering material, or protective member whereby one or more of said panel assemblies may be installed to form the walls of a bath tub, the walls of a shower, a counter top, a sink area, a restroom area, a kitchen or living area, or any part of any of the listed items or areas. The following also relates to panel assemblies comprising at least one tile, decorative ornament, covering material, or protective member whereby one or more of said panel assemblies may be installed on a wall frame, the frame of a building, or the skeleton of a room at a building.

2. Background of the Invention

Typically, the installation of tile, or other types of decorative or protective coverings, generally requires a variety of skilled artisans, is dirty and/or dusty, is expensive, is time consuming, entails working with materials that are hard to cut and size, uses materials that attract mold and mildew, produces a product that cracks easily, and usually the installation must be replaced after a relatively short time frame. Furthermore, the installation of tile and other types of decorative or protective coverings frequently requires strangers to enter the work area.

### SUMMARY OF THE INVENTION

Accordingly, the purpose of this application is to resolve these problems.

Other objectives of the invention will become apparent to those skilled in the art once the invention has been shown and described. The manner in which these objectives and other desirable characteristics can be obtained is explained in the following description and attached figures in which:

### BRIEF DESCRIPTION OF THE FIGURES

FIG. 1 is an exploded view of a panel assembly 1.

FIG. 2 is a perspective view of a panel assembly 1.

FIG. 3 is a perspective of a track 200.

FIG. 4 is a perspective of a shower 400 with at least one wall comprising a panel assembly 1.

FIG. 5 is a perspective of a bath 600 with at least one wall comprising a panel assembly 1.

FIG. 6 is rear-view of a waterproofed assembly of panel assemblies 1.

### DETAILED DESCRIPTION OF PREFERRED EMBODIMENTS

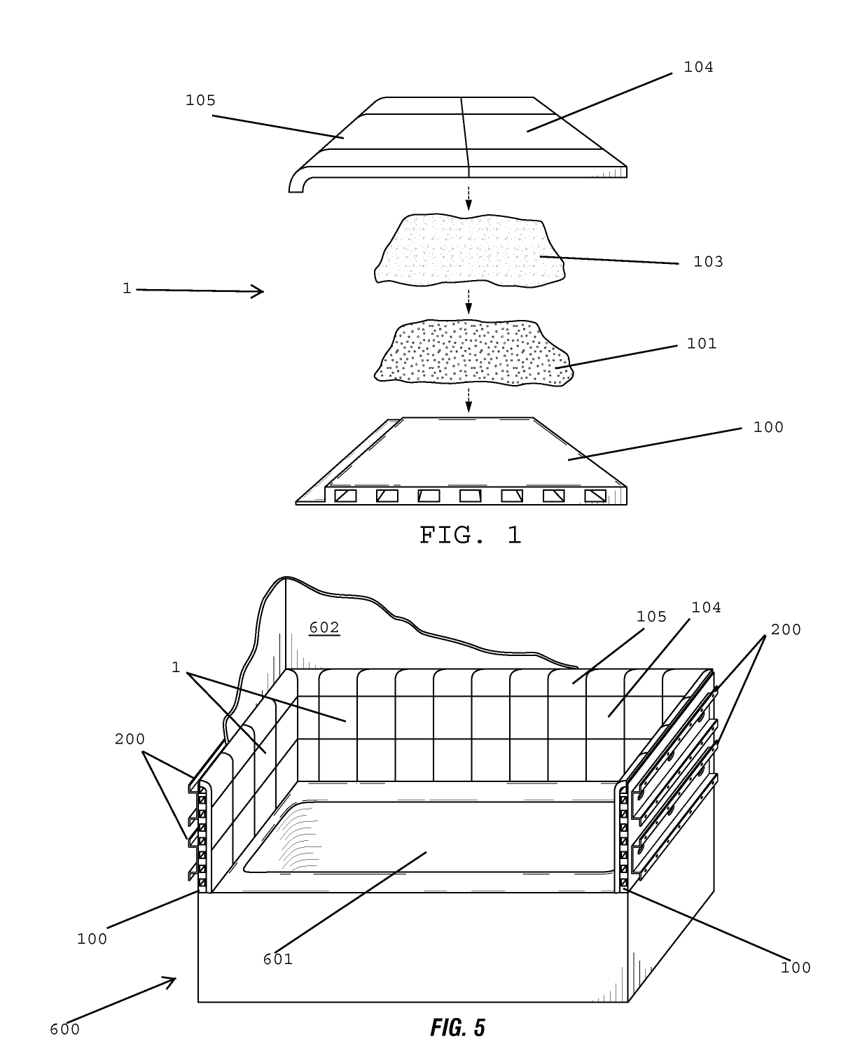

FIG. 1 is an exploded view of a preferred embodiment of the panel assembly 1 of the present application. As seen in the figure, the panel assembly 1 may comprise a preferably lightweight core 100, a granulated surface 101, mud/mortar 103, and at least one tile 104. In an alternate embodiment, the panel assembly may comprise a preferably lightweight core 100, with at least one tile 104 affixed thereto by epoxy, but without a granulated surface 101. In either preferable embodiment, the panel assembly 1 may also optionally comprise at least one edge tile 105.

FIG. 1 also indicates a preferable manner by which a panel assembly 1 is assembled. First, the core 100 receives a granulated surface 101. Finally, at least one tile 104 may be affixed to the granulated surface 101 via a mud/mortar 103. Additional tiles 104, including edge tiles 105, may optionally be adhered to the granulated surface 101 at random or designed locations. Another preferable manner by which a panel assembly 1 is assembled might be to affix at least one tile 104 to the core 100 with epoxy. Additional tiles 104, including edge tiles 105, may optionally be affixed to the core 100 at random or designed locations. FIG. 2 depicts an assembled panel assembly 1 assembled in either manner.

As mentioned above, the core 100 is preferably lightweight. However, the core 100 is also preferably sturdy. Accordingly, lightweight and sturdy materials (such as metals, plastics, woods, or composites thereof) are suitable to be used in the construction of the core 100. To reduce weight, the core 100 need not be completely solid. In the present embodiment, the core 100 is preferably aluminum in the form of electro-static honey-comb panels or honey-comb sandwich panels (previously used in aircraft and NASA applications). The core 100 could also be made of stainless steel, plastic, wood, or composites in the same honey-comb panel form. One skilled in the art will know additional materials and forms from which a suitable core 100 could be constructed.

As mentioned above, the core 100 may receive a granulated surface 103. Receiving a granulated surface 103 is particularly preferable when at least one tile 104 or 105 will be placed after the panel assembly 1 is installed. A core 100 may receive a granulated surface in many ways, for example: spreading an epoxy or other adhesive over a surface of the core 100, and then, before the epoxy or other adhesive dries, sprinkling grains of silica or other granular material over the spread. Any type of engrained epoxies, resins and adhesives may typically be used. However, the core 100 material may dictate the most preferable substances. If the core is aluminum, then the granulated surface 103 preferably comprises metal adhering epoxy with silica grains. One skilled in the art will appreciate other substances that are able to accomplish a granulated surface 103. If the tiles 104 and 105 are affixed directly to the core 100 via epoxy, then a granulated surface 101 is unnecessary.

The tile 104 and the edge tile 105 may be any type of item for decorative, ornamental, protective, covering, or waterproofing purpose. The tile 104 and edge tile 105 may be made of any type of ceramic, stone, metal, or glass. A tile 104 or edge tile 105 may also be slate, marble, glass, porcelain, or ceramic slurry. One skilled in the art will be aware of other types of tiles 104 and 105 and materials for tiles 104 and 105. Finally, the tile (104 and 105) surface may be treated with chemicals to prevent cracks, prevent the growth of mold or mildew, and eliminate stains from acids or alkalis.

One application of the panel assembly 1 is the creation of a countertop, table, or floor. Referring to FIG. 2, a one step process is required, namely: horizontally securing the core 100 of the panel assembly 1 to a support via adhesive. A sink may be added to a counter top by simply providing a hole to the panel assembly 1, securing the core 100 of the panel assembly 1 to a support via adhesive, and installing the sink at the hole provided to the panel assembly 1. Alternatively, a plurality of panel assemblies 1 may be pieced around the sink in the same manner described above. A drain could be installed in a floor in the same manner.

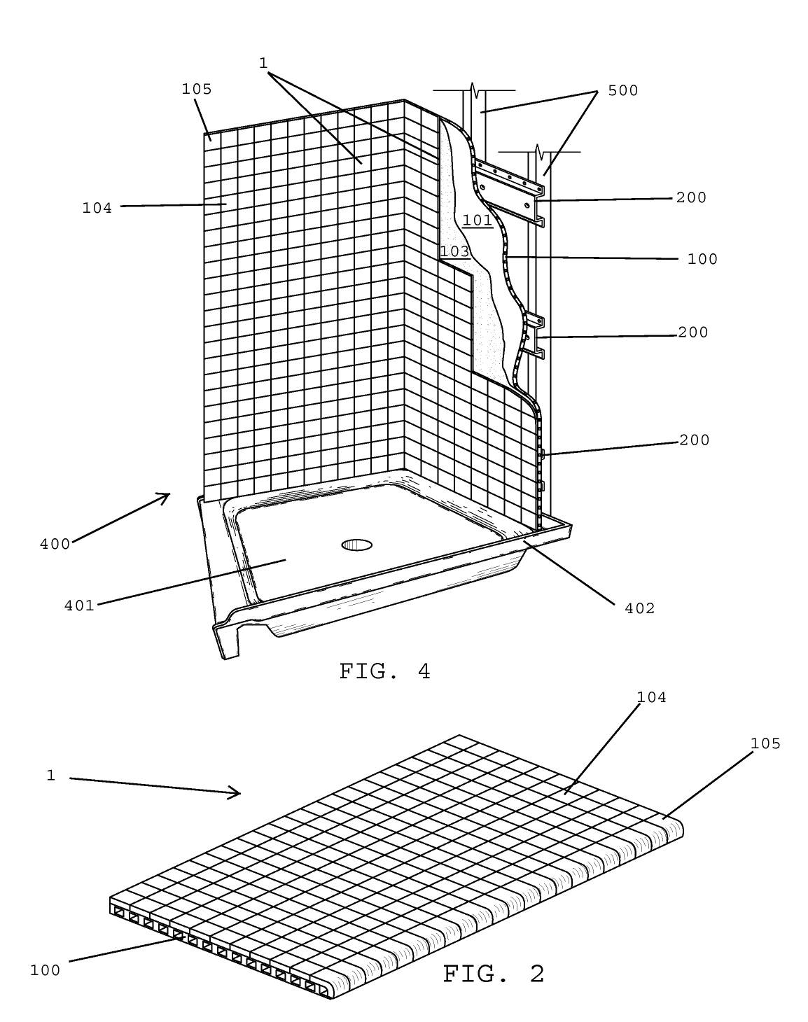

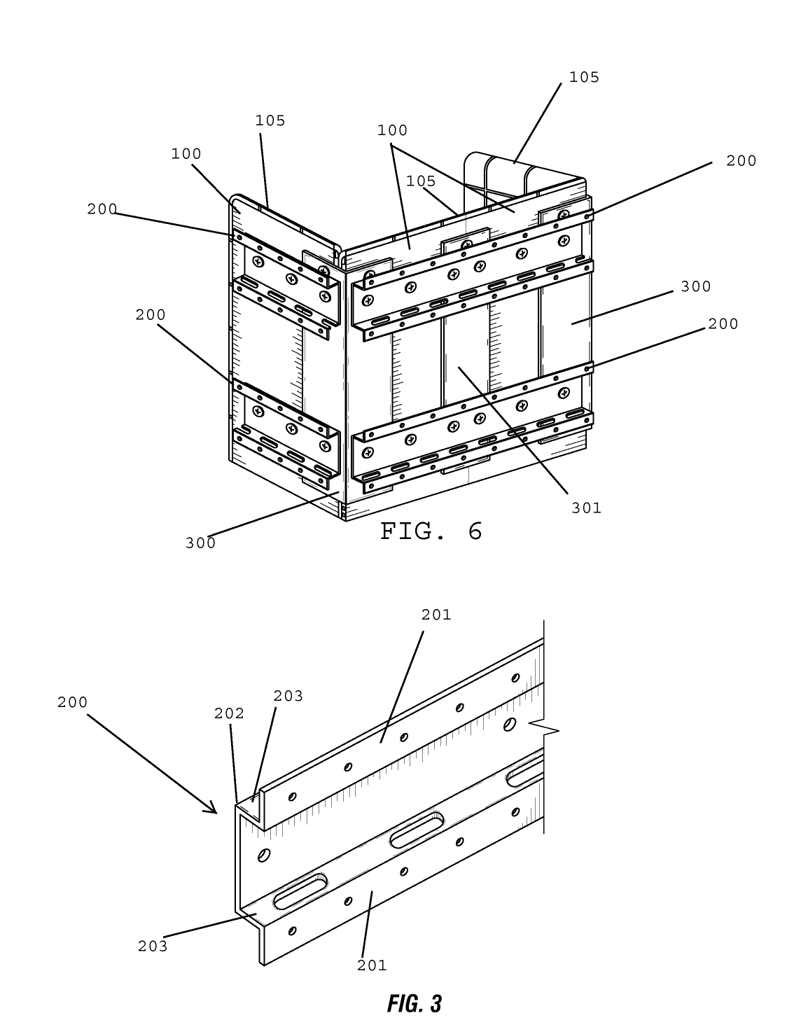

FIG. 3 depicts a track 200 which facilitates the instillation of a panel assembly 1. As seen in the figure, a track 200 preferably features at least one frame contact 201 which supports at least one panel contact 202 via at least one strut 203. Preferably, a track 200 represents an intermediary between the panel assembly 1 and a support or frame. Suitably, the intermediary relationship exists because typically the track 200 is affixed to a frame at the frame contact 201, and the panel assembly 1 (core 100 side) is typically affixed to the track 200 at the panel contact 202. To accommodate installation of a panel assembly 1, as discussed further below, the strut 203 should preferably provide separation of the frame contact 200 surface and the panel contact 202 surface to approximately the same width as sheetrock.

The track 200 should preferably be sturdy. Accordingly, a track 200 is preferably made from metallic materials. The track of the preferred embodiment is made of stainless steel and/or aluminum. One skilled in the art will know well other materials suitable for use as a track 200.

FIG. 4 is a depiction of a typical shower 400. In the figure, each wall is suitably defined by at least one panel assembly 1. One wall is cut away to show the inside of the shower 400. Another wall has been partially cut away to depict the components of the panel assembly 1 and the manner by which the panel assembly 1 was installed. As can be best seen in the figure behind the cut away walls, both depicted panel assemblies 1 are supported to the wall framing 500 via the tracks 200. Finally, the lip 402 of the shower pan 401 fits between the panel assembly 1 and the wall framing 500, in a general tongue and groove manner.

FIG. 5 is a depiction of a typical bathtub 600, partially bordered panel assemblies 1. In the figure, each wall of the tub 600 preferably comprises at least one panel assembly 1. The sheetrock 602 is cut away from around the tub 600 to depict the manner by which the panel assembly 1 was installed. As can be best seen in the figure behind the cut away sheetrock, the panel assemblies 1 are supported to the wall framing 500 via the tracks 200.

FIG. 6 depicts a rear perspective of a waterproofed assembly of panel assemblies 1, as might be employed around a shower, bathtub, or sink (waterproofed meaning impervious to water, moisture, and/or acetylene). As can be seen in the figure, corner pieces 300 are placed along the seam of adjacently positioned but non-coplanar panel assemblies 1. Middle pieces 301 may be placed along the seam of panel assemblies 1 that are adjacently positioned and coplanar. Assemblies of panel assemblies 1 are waterproofed through the use of corner pieces 300 and middle pieces 301 because water that passes through the seams of the assembled panel assemblies 1 will not further pass through the corner 300 and middle pieces 301 along the seams. Corner 300 and middle pieces 301 are preferably sheets of water resistant material. In the present embodiment, sheet-metal (typically stainless steel) has been used for the corner 300 and middle pieces 301. This will further improve the waterproofing that may have been accomplished by caulking.

Referring to FIGS. 2 through 6, panel assemblies may be installed around a shower 400 or bathtub 600 (or along any other vertical wall or vertical situation) as follows. Generally, assuming the wall framing 500 is exposed, the first step is placing the shower pan 401 or tub pan 601 adjacent to wall framing 500. If the wall framing 500 is not exposed, it must be exposed first. The stated step can be ignored if the panel assemblies 1 are not being installed to a shower or tub, or if the tub or shower does not comprise a tub or shower pan. Next, tracks 200 are affixed to the wall framing 500, typically frame contact 201 to wall framing 500. If the wall framing is wood, the stated affixation may be accomplished via screw, or via a wood-to-metal adhesive. Other means of affixation will be readily apparent to one skilled in the art and depending on the track 200 and wall framing 500 materials. The tracks 200 should typically be spaced along the wall framing at what would be the middle, just below the top, and just above the bottom of the panel assembly 1 to be installed—although other spacing is contemplated.

Still referring to FIGS. 2 through 6, the next step is preferably to affix corner 300 and middle pieces 301 along the tracks 200 at the locations of panel assembly 1 seams. This step is unnecessary if waterproofing is not desired. In the typical installation, the center 300 and middle pieces 400 should approximately extend along the entire panel assembly 1. This affixation may be accomplished via screw or adhesive. In the present embodiment the stainless steel center 300 and middle 301 pieces are affixed to the stainless steel tracks 200 via steel-to-steel adhesive.

Still referring to FIGS. 2 through 6, the next preferable step is to provide holes to the panel assemblies 1 to accommodate utilities. Typically, a hole may be provided to the panel assembly if a light switch or shower head or faucet needs to be accessible at a central location of a panel assembly 1. This step may be ignored if no holes are necessary for the installation. Installation is completed by affixing the panel assembly 1 to the tracks 200 and the corner 300 and middle pieces 301. Generally, affixation is accomplished via metal to metal adhesive (in the present embodiment aluminum-to-steel adhesive). If sheet rock will be present at the top or bottom of the panel assembly 1, the sheetrock should be placed between the framing 500 and the panel assembly (including corner 300 and middle pieces 301) similar to a tongue and groove, as depicted in FIG. 5. As mentioned above (and depicted in FIG. 4), the lip 402 of the shower pan 401 should also be placed between the panel assembly 1 (including corner 300 and middle pieces 301) like a tongue and groove. Additional finishing may be provided to the installed panel, for example, caulk.

It should be kept in mind that the order on performance of steps during installation or assembly of the panel assembly 1 may be altered. For an example of altered order on performance of installation, the tracks 200 may be affixed to the panel assembly 1 before the panel assembly and track 200 are affixed to the wall frame 500 instead of affixing the tracks 200 to the wall frame 500 before having the panel affixed to the track 200. Other adaptations in the order on performance of steps during installation or assembly of the panel assembly 1 will be readily apparent to those skilled in the art.

It should be noted that it is intended that users may purchase pre-fabricated panel assemblies 1 as part of “do-it-yourself” kits in standardized sizes, which may be readily used to retrofit an old bathroom, for example, with tiled walls. It is also contemplated that the kits may feature one or more shower walls that comprise a panel assembly. It is also contemplated that the kits may feature one or more bathroom walls that comprise a panel assembly. It is also contemplated that the kits may include a sink counter with a hole provided thereto for installing a sink, faucet, and the like, said counter comprising at least one panel assembly. It is also contemplated that the kits may include a shower wall with a hole provided thereto for installing a faucet, spigot, temperature dial, and the like, said wall comprising at least one panel assembly. It is also contemplated that the kits may include the appropriate tools for installing walls or panel assemblies, including but not limited to, epoxy applicators, levels, tracks, screws, caulk. It is also contemplated that the kits may contain additional components including plumbing pipes, spigots, faucets and the like for installing any associated plumbing. It is also contemplated that the kits may include electric wiring and controls for installing associated electrical components.

It is noteworthy that the present application discloses a method of creating a water resistant and mildew resistant environment in bathroom settings. Whereas prior methodologies have involved separate professionals or steps to waterproof sheetrock, lay tile, and install plumbing apparatus, the present application drastically reduces the time necessary to accomplish a similar end because prefabricated tile assemblies 1 may be purchased in pre-sized modules. The step of cutting, laying, and setting tile is not necessary for the user of the kit. Rather, the panel assemblies 1 may be directly connected to framing 500 via a fastening means. In this case the fastening means preferably comprise track members 200 and epoxy resins or screws. The dry times of the epoxy resins are relatively short when compared to the dry times of mortar or mud under a typical shower or bath installation involving tile. Suitably, the kits may feature tiles in a vast assortment of colors, shapes, and sizes. Following installation, the end user has another benefit in that the entire installation is typically fashioned from moisture resistant and mildew resistant materials. Moreover, this application discloses a method of using a kit to install tiled surfaces so that it is entirely possible to do in a work day of under 12 hours, what would typically take significantly longer periods of time. The user of a kit, for a tiled shower installation, for example, could go from bare studs to a tiled, fully operable shower surface in a day—without having to wait for tiles and mortar to dry. These pre-fabricated decorated surfaces may be further used on exterior surfaces, on building sides for instance, to create water resistant surfaces. Tunnels and underground facilities are also locations where tile is frequently used, and pre-fabricated tile kits can be employed.

It will be appreciated that the above described embodiments are given by example only and that various modifications thereto may be made without departing from the scope of the invention.

I claim:

1. A modular panel comprising:
a core; and,
at least one decorative or protective member attached to the core.

2. The modular panel of claim 1 further comprising an adhering means for securing the decorative or protective member(s) to the core.

3. The modular panel of claim 1 wherein the core is constructed of at least one electro-static honey-comb panel.

4. The modular panel of claim 1 further comprising:
a granulated surface on said core; and,
a mortar for securing the decorative or protective member to the core via the granulated surface.

5. The modular panel of claim 4 wherein the granulated surface comprises at least one grain of silica mixed with an adhesive.

6. The modular panel of claim 5 wherein the decorative or protective member is a tile fabricated from any of the materials selected from the group consisting essentially of ceramic, stone, metal, glass slate, or marble, glass, porcelain, or ceramic slurry.

7. The modular panel of claim 6 wherein the core is dimensioned for establishing a surface selected from the group consisting essentially of a counter-top, a shower wall, or a bath wall.

8. The modular panel of claim 4 further comprising a track.

9. The modular panel of claim 8 further comprising a securing means for adhering the panel to a support via the track.

10. A method of fabricating a modular panel comprising the steps of:
obtaining a core;
providing a granulated surface to the core by adhering at least one silica bead thereto; and,
affixing at least one decorative or protective member to the core via the granulated surface.

11. The method of claim 10 wherein the core is constructed of at least one electro-static honey-comb panel.

12. The method of claim 11 further comprising the step of applying a mortar to the granulated surface before securing the decorative or protective member to the core.

13. The method of claim 12 wherein the decorative or protective member is a tile fabricated from any of the materials selected from the group consisting essentially of ceramic, stone, metal, glass slate, or marble, glass, porcelain, or ceramic slurry.

14. The method of claim 13 wherein the core is dimensioned for establishing a surface selected from the group consisting essentially of a counter-top, a shower wall, or a bath wall.

15. a system of modular panels comprising:
a first modular panel featuring a first core with at least one decorative or protective member secured thereto via a granulated surface on the core;
a second modular panel featuring a second core adjacent the first core; and,
a means for water-proofing the seam between the first and second core.

16. The system of claim 15 wherein the first and second modular panels are at an angle of approximately 90 degrees relative to one another.

17. A method of installing a modular panel comprising the steps of:
obtaining the modular panel, said modular panel featuring a core with at least one decorative or protective member secured thereto via a granulated surface on the core and;
obtaining at least one track; and,
securing the track(s) to the modular panel and a support frame.

18. The method of claim 17 wherein the core is constructed of at least one electro-static honey-comb panel.

19. The method of claim 18 further comprising the step of applying a mortar to the granulated surface before securing the decorative or protective member to the core.

20. The method of claim 19 wherein the decorative or protective member is a tile fabricated from any of the materials selected from the group consisting essentially of ceramic, stone, metal, glass slate, or marble, glass, porcelain, or ceramic slurry.
